(19) United States
(12) Patent Application Publication
(10) Pub. No.: US 2026/0186687 A1
(43) Pub. Date: Jul. 2, 2026

(54) OPERATION METHODS OF STORAGE CONTROLLER AND STORAGE DEVICE INCLUDING STORAGE CONTROLLER, AND STORAGE SYSTEM INCLUDING STORAGE DEVICE

(71) Applicant: Samsung Electronics Co., Ltd., Suwon-si (KR)

(72) Inventors: EUNKYUNG PARK, Suwon-si (KR); JANGHWAN KIM, Suwon-si (KR); DURINA PARK, Suwon-si (KR); SUNG-HWAN BAE, Suwon-si (KR); SYUNGKI LEE, Suwon-si (KR); HYUNJOO JUNG, Suwon-si (KR); KANGHO ROH, Suwon-si (KR); HEEWON LEE, Suwon-si (KR)

(21) Appl. No.: 19/396,777

(22) Filed: Nov. 21, 2025

(30) Foreign Application Priority Data
Dec. 30, 2024 (KR) 10-2024-0200463

(51) Int. Cl. G06F 3/06

(52) U.S. Cl. CPC G06F 3/0652; G06F 3/0604; G06F 3/0679

(57) ABSTRACT

Disclosed is an operation method of a storage device which includes a storage controller and a non-volatile memory device. The operation method includes providing, by the storage controller, an erase command to the non-volatile memory device, and providing, by the storage controller, the non-volatile memory device with a first program command and first page data during an erase time period in which the non-volatile memory device is in a busy state in response to the erase command.

### CROSS-REFERENCE TO RELATED APPLICATIONS

This application claims priority under 35 U.S.C. § 119 to Korean Patent Application No. 10-2024-0200463 filed on Dec. 30, 2024, in the Korean Intellectual Property Office, the disclosures of which are incorporated by reference herein in their entireties.

### BACKGROUND

Embodiments of the present disclosure described herein relate to a storage system, and more particularly, relate to an operation method of a storage controller and a storage device including the storage controller, and the storage system including the storage device.

A memory device stores data in response to a write request and outputs data stored therein in response to a read request. For example, the memory device is classified as a volatile memory device, which loses data stored therein when power is turned off, such as a dynamic random access memory (DRAM) device and a static RAM (SRAM) device, or a non-volatile memory device, which retains data stored therein even when power is turned off, such as a flash memory device, a phase-change RAM (PRAM), a magnetic RAM (MRAM), and a resistive RAM (RRAM).

As a kind of a non-volatile memory device, a flash memory is used as a high-capacity storage medium due to advantages such as a high capacity and low noise. An operation speed of one flash memory may be slower than an operation speed of any other storage medium, but the operation speed of the flash memory may be improved by using a plurality of flash memories in parallel. Nowadays, as an interface speed and a data processing speed of a processor increase, various techniques for improving the performance of the flash memory are being developed.

### SUMMARY

Embodiments of the present disclosure provide a storage system reducing a write buffer occupancy time in a program operation, an operation method of a storage device, and an operation method of a storage controller.

According to an aspect of the present disclosure, an operation method of a storage device which includes a storage controller and a non-volatile memory device includes providing, by the storage controller, an erase command to the non-volatile memory device, and providing, by the storage controller, the non-volatile memory device with a first program command and first page data during an erase time period in which the non-volatile memory device is in a busy state in response to the erase command.

According to an aspect of the present disclosure, an operation method of a storage controller which communicates with a non-volatile memory device includes providing the non-volatile memory device with an erase command for a first memory block of the non-volatile memory device, and providing the non-volatile memory device with a first program command and first page data during an erase time period in which the non-volatile memory device is in a busy state in response to the erase command.

According to an aspect of the present disclosure, a storage system includes a host, and a storage device that includes a storage controller and a non-volatile memory device and communicates with the host. The storage controller receives a program request provided from the host, provides the non-volatile memory device with an erase command for a first memory block of the non-volatile memory device, based on the program request, and provides the non-volatile memory device with a first program command and first page data associated with a first page of the first memory block, during an erase time period in which the non-volatile memory device is in a busy state in response to the erase command.

### BRIEF DESCRIPTION OF THE FIGURES

The above and other objects and features of the present disclosure will become apparent by describing in detail embodiments thereof with reference to the accompanying drawings.

FIG. 1 is a block diagram of a storage system according to an embodiment of the present disclosure.

FIG. 2 is a block diagram illustrating a storage controller of FIG. 1 in detail, according to some embodiments of the present disclosure.

FIG. 3 is a block diagram illustrating a non-volatile memory device of FIG. 1 in detail, according to some embodiments of the present disclosure.

FIG. 4 is a diagram describing a memory block of a memory cell array of FIG. 3, according to some embodiments of the present disclosure.

FIG. 5 is a block diagram of a storage device according to some embodiments of the present disclosure.

FIG. 6 is a timing diagram describing an erase operation and a program operation of a conventional storage device.

FIG. 7 is a diagram describing an operation method of a storage device according to some embodiments of the present disclosure.

FIG. 8 is a timing diagram describing an erase operation and a program operation of a storage device according to some embodiments of the present disclosure.

FIG. 9 is a timing diagram describing a threshold time according to some embodiments of the present disclosure.

FIG. 10 is a timing diagram describing a program operation of a storage device in a multi-level cell (MLC) manner according to some embodiments of the present disclosure.

FIG. 11 is a timing diagram describing a program operation of a storage device in a triple level cell (TLC) manner according to some embodiments of the present disclosure.

FIG. 12 is a timing diagram describing a threshold time according to some embodiments of the present disclosure.

FIG. 13 is a flowchart describing an operation method of a storage device according to some embodiments of the present disclosure.

### DETAILED DESCRIPTION

Below, embodiments of the present disclosure will be described in detail and clearly to such an extent that one skilled in the art carries out embodiments of the present disclosure easily.

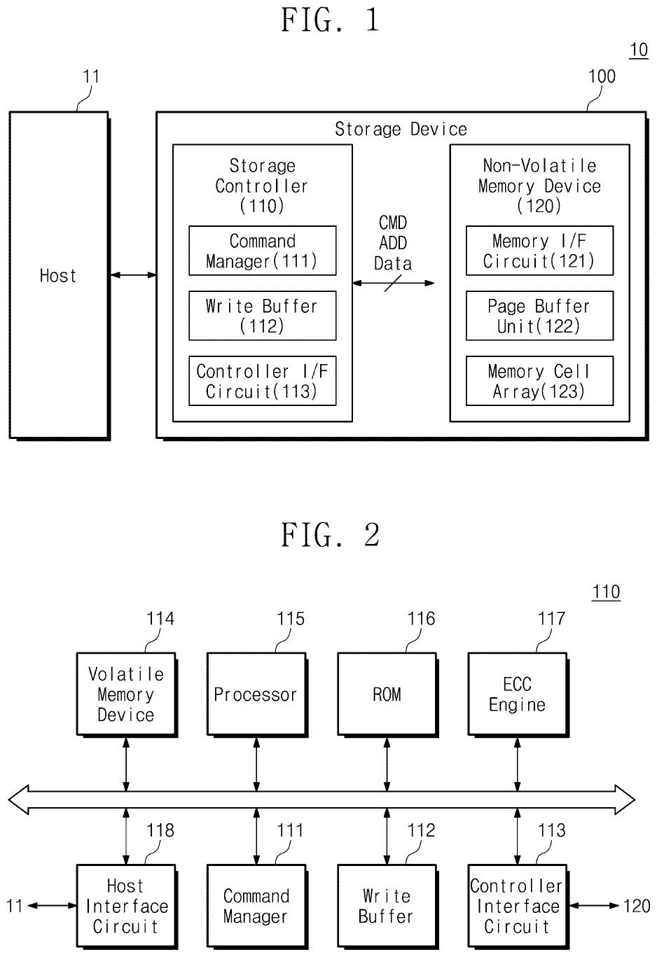

FIG. 1 is a block diagram of a storage system 10 according to an embodiment of the present disclosure. Referring to FIG. 1, the storage system 10 may include a host 11 and a storage device 100. In some embodiments, the storage system 10 may refer to a computing system, which is configured to process a variety of information, such as a personal computer (PC), a notebook, a laptop, a server, a workstation, a tablet PC, a smartphone, a digital camera, and a black box.

The host 11 may control all operations of the storage system 10. For example, the host 11 may store data in the storage device 100 or may read data stored in the storage device 100.

The storage device 100 may include a storage controller 110 and a non-volatile memory device 120. The non-volatile memory device 120 may store data. The storage controller 110 may store data in the non-volatile memory device 120 or may read data stored in the non-volatile memory device 120. The non-volatile memory device 120 may operate under control of the storage controller 110. For example, based on a command CMD indicating an operation and an address ADD indicating a location of data, the storage controller 110 may store data in the non-volatile memory device 120 or may read data stored in the non-volatile memory device 120.

In some embodiments, the non-volatile memory device 120 may be a NAND flash memory device, but the present disclosure is not limited thereto. For example, the non-volatile memory device 120 may be one of various storage devices, which retain data stored therein even when power is turned off, such as a phase-change random access memory (PRAM), a magnetic random access memory (MRAM), a resistive random access memory (RRAM), and a ferroelectric random access memory (FRAM).

The storage controller 110 may include a command manager 111, a write buffer 112, and a control interface circuit 113.

The command manager 111 may manage various commands indicating operations to be performed in the non-volatile memory device 120. For example, the command manager 111 may provide the non-volatile memory device 120 with various commands such as a read command, a program command, and an erase command.

When the command manager 111 provides the program command to the non-volatile memory device 120, the command manager 111 may determine whether a command most recently provided to the non-volatile memory device 120 (i.e., an immediately preceding command issued to the non-volatile memory device 120 relative to the issuance of the program command) is the erase command. In response to determining that the command most recently provided to the non-volatile memory device 120 is the erase command, the command manager 111 may provide the program command to the non-volatile memory device 120 while the erase operation is performed by the erase command. In this case, it is obvious to one skilled in the art that program data are provided to the non-volatile memory device 120 together with the program command.

In some embodiments, the storage device 100 may first perform the erase operation on a memory block of the non-volatile memory device 120 before storing (i.e., programming) data in the corresponding memory block. For example, the above erase command may be an erase command indicating the above erase operation, and the above program command may be a program command indicating the above program operation.

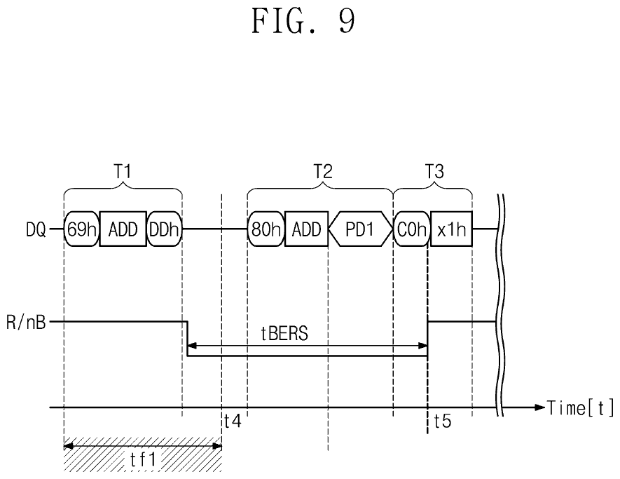

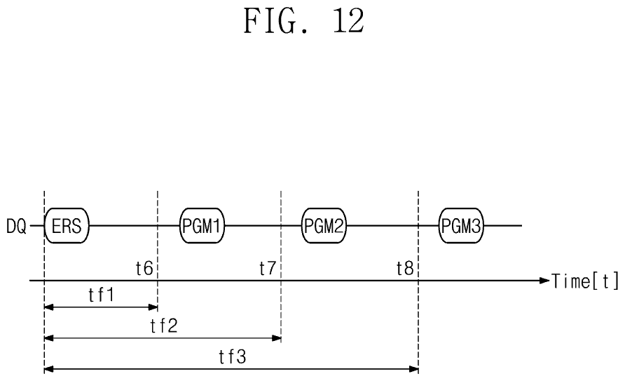

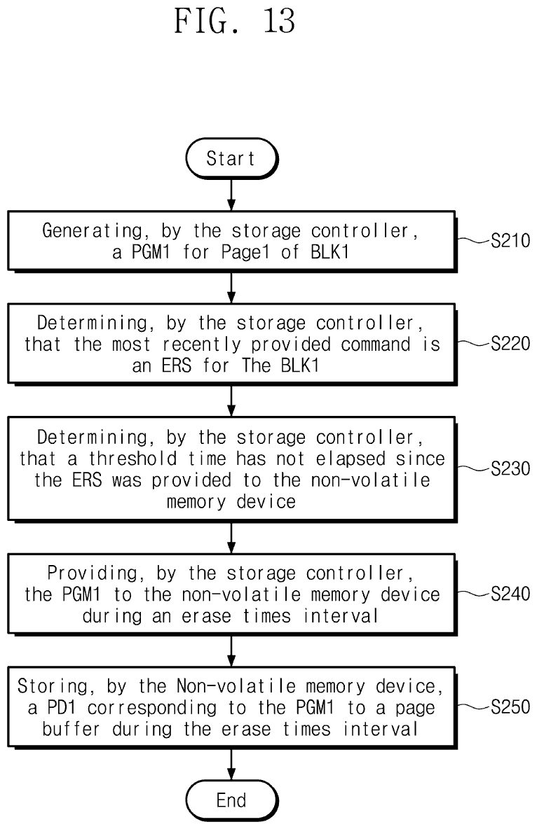

In some embodiments, when the command manager 111 provides the program command to the non-volatile memory device 120, the command manager 111 may determine whether a threshold time does not elapse from a time point at which the immediately previous erase command is provided to the non-volatile memory device 120. Based on determining that the threshold time does not elapse from the time point at which the immediately previous erase command is provided to the non-volatile memory device 120, the command manager 111 may provide the non-volatile memory device 120 with the program command during a time when the erase operation based on the erase command is performed. For example, the threshold time may be a preset time. The threshold time will be described in detail with reference to FIGS. 9 and 12.

In some embodiments, the command manager 111 may manage a latch dump command. The non-volatile memory device 120 may perform a latch dump operation based on the latch dump command, which will be described in detail with reference to a page buffer unit 122.

The write buffer 112 may temporarily store program data corresponding to a program request provided from the host 11. The write buffer 112 may temporarily store read data obtained from the non-volatile memory device 120. The storage controller 110 may provide the read data obtained from the write buffer 112 to the host 11.

In some embodiments, the command manager 111 may obtain the program data from the write buffer 112 and may provide the program data to the non-volatile memory device 120 together with the program command.

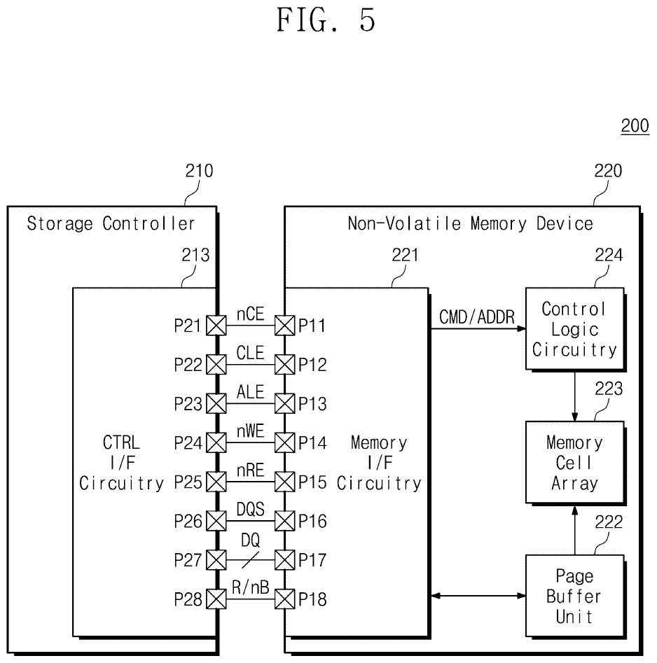

The storage controller 110 may communicate with the non-volatile memory device 120 through the controller interface circuit 113. The storage controller 110 may provide the command CMD, the address ADD, and data to the non-volatile memory device 120 through the controller interface circuit 113. This will be described in detail with reference to FIG. 5.

In some embodiments, the controller interface circuit 113 may be implemented based on the NAND interface.

The non-volatile memory device 120 may include a memory interface circuit 121, the page buffer unit 122, and a memory cell array 123.

The non-volatile memory device 120 may communicate with the storage controller 110 through the memory interface circuit 121. For example, the memory interface circuit 121 may communicate with the controller interface circuit 113. This will be described in detail with reference to FIG. 5.

The page buffer unit 122 may store the program data provided in the storage controller 110 and may then provide the program data to the memory cell array 123. The page buffer unit 122 may temporarily store the read data read from the memory cell array 123 and may then provide the read data to the storage controller 110.

In some embodiments, the page buffer unit 122 may include a plurality of page buffers. Each page buffer may include a cache latch circuit and a plurality of data latch circuits. The cache latch circuit may temporarily store the program data received from the storage controller 110. The program data stored in the cache latch circuit may be dumped to at least one of the plurality of data latch circuits (i.e., through the latch dump operation) in response to the latch dump command received from the storage controller 110.

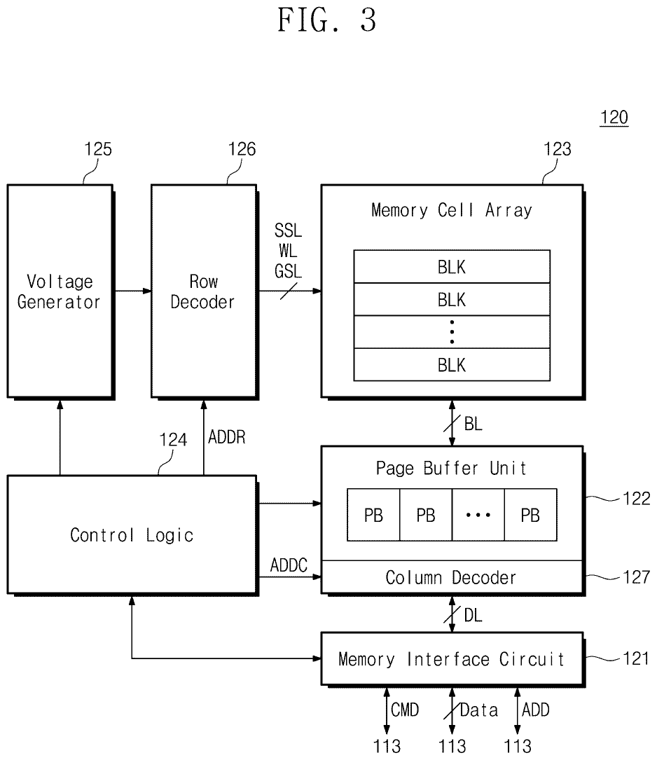

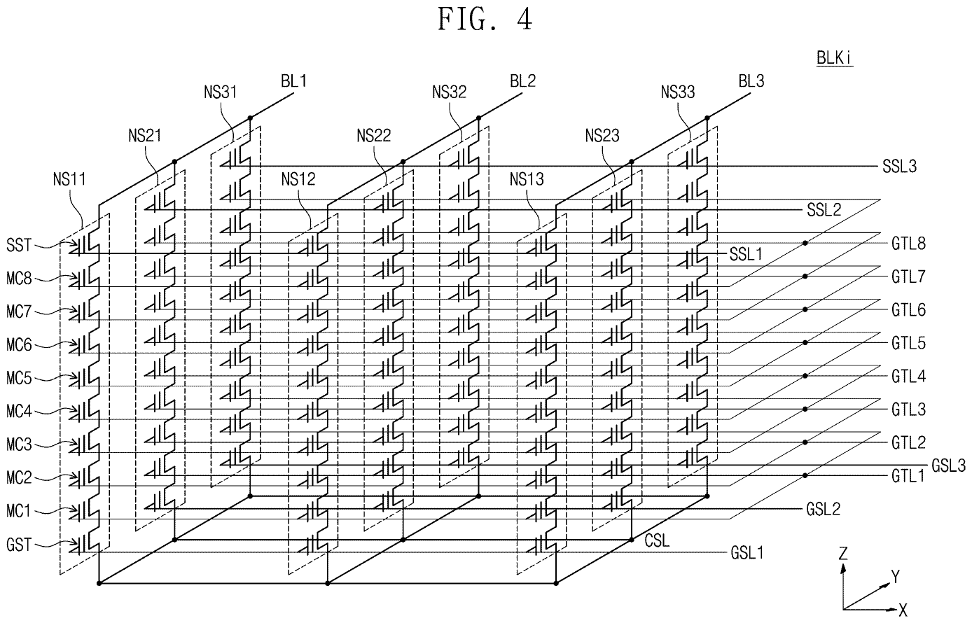

The memory cell array 123 may include a plurality of memory blocks, and each of the plurality of memory blocks may include a plurality of pages. This will be described in detail with reference to FIGS. 3 and 4.

FIG. 2 is a block diagram illustrating the storage controller 110 of FIG. 1 in detail, according to some embodiments of the present disclosure. Referring to FIGS. 1 and 2, the storage controller 110 may communicate with the host 11 and the non-volatile memory devices 120. The storage controller 110 may include the command manager 111, the write buffer 112, the controller interface circuit 113, a volatile memory device 114, a processor 115, a read only memory (ROM) 116, an error correcting code (ECC) engine 117, and a host interface circuit 118.

The command manager 111 may manage commands indicating operations to be performed in the non-volatile memory device 120. The write buffer 112 may temporarily store program data and read data. The controller interface circuit 113 may communicate with the non-volatile memory device 120.

In some embodiments, the command manager 111 may be implemented with a firmware module. For example, the processor 115 may implement the command manager 111 by loading instructions stored in the non-volatile memory device 120 to the volatile memory device 114 and executing the loaded instructions. However, the scope of the present disclosure is not limited thereto. For example, the command manager 111 may be implemented with separate hardware or may be implemented with a combination of hardware and software.

The volatile memory device 114 may be used as a main memory, a buffer memory, or a cache memory of the storage controller 110. The processor 115 may control all operations of the storage controller 110. The ROM 116 may be used as a read only memory which stores information necessary for the operation of the storage controller 110.

In some embodiments, for convenience of description, the volatile memory device 114 and the write buffer 112 are illustrated as separate components, but the volatile memory device 114 may include the write buffer 112.

The ECC engine 117 may detect and correct an error of data obtained from the non-volatile memory device 120. For example, the ECC engine 117 may have an error correction capability of a given level. The ECC engine 117 may manage data having an error level (e.g., the number of flipped bits) exceeding the error correction capability as an uncorrectable error.

In some embodiments, the ECC engine 117 may encode the program data received from the host 11 so as to be provided to the write buffer 112. Also, the ECC engine 117 may decode the read data which are read from the non-volatile memory device 120 and are then stored in the write buffer 112, so as to be provided to the host 11.

The storage controller 110 may communicate with the host 11 through the host interface circuit 118. In some embodiments, the host interface circuit 118 may be implemented based on at least one of various interfaces such as a serial ATA (SATA) interface, a peripheral component interconnect express (PCIe) interface, a serial attached SCSI (SAS), a non-volatile memory express (NVMe) interface, and a universal flash storage (UFS) interface.

FIG. 3 is a block diagram illustrating the non-volatile memory device 120 of FIG. 1 in detail, according to some embodiments of the present disclosure. FIG. 4 is a diagram describing a memory block of the memory cell array 123 of FIG. 3, according to some embodiments of the present disclosure.

Referring to FIGS. 1, 3, and 4, the non-volatile memory device 120 may communicate with the storage controller 110. For example, the non-volatile memory device 120 may receive the command CMD and the address ADD from the controller interface circuit 113 of the storage controller 110 through the memory interface circuit 121. The non-volatile memory device 120 may perform data communication with the storage controller 110.

The non-volatile memory device 120 may include the memory interface circuit 121, the page buffer unit 122, the memory cell array 123, control logic 124, a voltage generator 125, a row decoder 126, and a column decoder 127.

The control logic 124 may receive the command CMD and the address ADD from the storage controller 110 through the memory interface circuit 121. The command CMD may refer to a signal indicating an operation to be performed by the non-volatile memory device 120, such as a read operation, a program operation, and an erase operation. The address ADD may include a row address ADDR and a column address ADDC. The control logic 124 may control all operations of the non-volatile memory device 120 based on the command CMD and the address ADD. The control logic 124 may generate the row address ADDR and the column address ADDC based on the address ADD.

Under control of the control logic 124, the voltage generator 125 may control voltages to be applied to the memory cell array 123 through the row decoder 126.

The row decoder 126 may receive the row address ADDR from the control logic 124. The row decoder 126 may be connected to the memory cell array 123 through string selection lines SSL, word lines WL, and ground selection lines GSL. The row decoder 126 may decode the row address ADDR and may control voltages to be applied to the string selection lines SSL, the word lines WL, and the ground selection lines GSL based on a decoding result and voltages received from the voltage generator 125.

The memory cell array 123 may include a plurality of memory blocks BLK. Each of the plurality of memory blocks BLK may be similar in structure to a memory block BLKi illustrated in FIG. 4. The memory block BLKi illustrated in FIG. 4 may correspond to a physical erase unit of the non-volatile memory device 120, but the present disclosure is not limited thereto. For example, the physical erase unit may be changed to a page unit, a word line unit, or a sub-block unit. The memory block BLKi illustrated in FIG. 4 indicates a three-dimensional memory block formed on a substrate in a three-dimensional structure. For example, a plurality of memory NAND strings included in the memory block BLKi may be formed in a direction perpendicular to the substrate.

Below, for convenience of description, a first direction X, a second direction Y, and a third direction Z are mentioned. The first direction X may be a direction parallel to an upper surface of the substrate where the memory block BLKi is formed. The second direction Y may be a direction parallel to the upper surface of the substrate and perpendicular to the first direction X. The third direction Z may be a direction perpendicular to a plane defined by the first direction X and the second direction Y. For example, the third direction Z may be a direction perpendicular to the upper surface of the substrate. The first direction X, the second direction Y, and the third direction Z may be referred to as a “row direction”, a “column direction”, and a “height direction”, respectively.

As illustrated in FIG. 4, the memory block BLKi may include a plurality of memory NAND strings NS11 to NS33 connected between bit lines BL1, BL2, and BL3 and a common source line CSL. The plurality of memory NAND strings NS11 to NS33 may be arranged in the first direction X and the second direction Y.

Memory NAND strings belonging to the same column from among the plurality of memory NAND strings NS11 to NS33 may be connected to the same bit line.

Each of the plurality of memory NAND strings NS11 to NS33 may include a string selection transistor SST, a plurality of memory cells MC1, MC2, . . . , MC8, and a ground selection transistor GST. An embodiment in which each of the plurality of memory NAND strings NS11 to NS33 includes eight memory cells MC1, MC2, . . . , MC8 is illustrated in FIG. 4, but the present disclosure is not necessarily limited thereto. The plurality of memory cells MC1, MC2, . . . , MC8 may be stacked in the third direction Z.

The string selection transistor SST may be connected to a corresponding one of string selection lines SSL1, SSL2, and SSL3. The plurality of memory cells MC1, MC2, . . . , MC8 may be respectively connected to gate lines GTL1, GTL2, . . . , GTL8. The gate lines GTL1, GTL2, . . . , GTL8 may correspond to word lines, and some of the gate lines GTL1, GTL2, . . . , GTL8 may correspond to dummy word lines. The ground selection transistor GST may be connected to a corresponding one of ground selection lines GSL1, GSL2, and GSL3. The string selection transistor SST may be connected to a corresponding bit line among the bit lines BL1, BL2, and BL3, and the ground selection transistor GST may be connected to the common source line CSL.

Word lines at the same height may be connected in common, and the ground selection lines GSL1, GSL2, and GSL3 and the string selection lines SSL1, SSL2, and SSL3 may be separated from each other. An embodiment in which the memory block BLKi is connected to eight gate lines GTL1, GTL2, . . . , GTL8 and three bit lines BL1, BL2, and BL3 is illustrated in FIG. 4, but the present disclosure is not necessarily limited thereto.

In some embodiments, the memory block BLK may include a plurality of pages. For example, the first memory cells MC1 of the memory NAND strings NS11, NS12, NS13, NS21, NS22, NS23, NS31, NS32, and NS33, which are connected to the first gate line GTL1, may be referred to as a “first physical page”.

In some embodiments, one physical page may correspond to a plurality of logical pages. For example, when the first memory cell MC1 is a triple level cell (TLC) storing information corresponding to three bits, a physical page may correspond to three logical pages.

Returning to FIGS. 1 and 3, the page buffer unit 122 may include a plurality of page buffers PB. The page buffer unit 122 may be connected to the memory cell array 123 through bit lines BL. Data read from the memory cell array 123 in units of page, by sensing voltages of the bit lines BL, may be stored in the page buffer unit 122.

The column decoder 127 may receive the column address ADDC from the control logic 124. The column decoder 127 may decode the column address ADDC and may provide the data stored in the page buffer unit 122 to the memory interface circuit 121 based on a decoding result.

The column decoder 127 may receive data from the memory interface circuit 121 through data lines DL. The column decoder 127 may receive the column address ADDC from the control logic 124. The column decoder 127 may decode the column address ADDC and may provide the data received from the memory interface circuit 121 to the page buffer unit 122 based on a decoding result. The page buffer unit 122 may store the data provided from the memory interface circuit 121 in the memory cell array 123 through the bit lines BL in units of page.

The memory interface circuit 121 may be connected to the column decoder 127 through the data lines DL. The memory interface circuit 121 may provide data received from the storage controller 110 to the column decoder 127 through the data lines DL. The memory interface circuit 121 may output data received through data lines DL to the storage controller 110.

FIG. 5 is a block diagram of a storage device 200 of according to some embodiments of the present disclosure. Referring to FIG. 5, the storage devices 200 may include a non-volatile memory device 220 and a storage controller 210. The storage controller 210 and the non-volatile memory device 220 may respectively correspond to the storage controller 110 and the non-volatile memory device 120 of FIG. 1.

The non-volatile memory device 220 may include first to eighth pins P11 to P18, memory interface circuitry 221, a memory cell array 223, and a control logic circuitry 224.

The memory interface circuitry 221 may receive a chip enable signal nCE from the storage controller 210 through the first pin P11. The memory interface circuitry 221 may transmit and receive signals to and from the storage controller 210 through the second to eighth pins P12 to P18 in response to the chip enable signal nCE. For example, when the chip enable signal nCE is in an enable state (e.g., at a low level), the memory interface circuitry 221 may transmit and receive signals to and from the storage controller 210 through the second to eighth pins P12 to P18.

The memory interface circuitry 221 may receive a command latch enable signal CLE, an address latch enable signal ALE, and a write enable signal nWE from the storage controller 210 through the second to fourth pins P12 to P14. Through the seventh pin P17, the memory interface circuitry 221 may receive a data signal DQ from the storage controller 210 or may transmit the data signal DQ to the storage controller 210. The command CMD, the address ADDR, and data may be transmitted through the data signal DQ. For example, the data signal DQ may be transferred through a plurality of data signal lines. In this case, the seventh pin P17 may include a plurality of pins corresponding to the plurality of data signals DQ.

The memory interface circuitry 221 may obtain the command CMD from the data signal DQ which is received in an enable section (e.g., a high-level state) of the command latch enable signal CLE based on toggle timings of the write enable signal nWE. The memory interface circuitry 221 may obtain the address ADDR from the data signal DQ which is received in an enable section (e.g., a high-level state) of the address latch enable signal ALE based on the toggle timings of the write enable signal nWE.

In an example embodiment, the write enable signal nWE may be maintained in a static state (e.g., at a high level or a low level) and may toggle between the high level and the low level. For example, the write enable signal nWE may toggle in a time period in which the command CMD or the address ADDR is transmitted. Thus, the memory interface circuitry 221 may obtain the command CMD or the address ADDR based on toggle timings of the write enable signal nWE.

The memory interface circuitry 221 may receive a read enable signal nRE from the storage controller 210 through the fifth pin P15. The memory interface circuitry 221 may receive a data strobe signal DQS from the storage controller 210 through the sixth pin P16 or may transmit the data strobe signal DQS to the storage controller 210.

In a data output operation of the non-volatile memory device 220, the memory interface circuitry 221 may receive the read enable signal nRE, which toggles through the fifth pin P15, before outputting data “DATA”. The memory interface circuitry 221 may generate the data strobe signal DQS toggling, based on the toggling of the read enable signal nRE. For example, the memory interface circuitry 221 may generate the data strobe signal DQS that starts to toggle after a given delay (e.g., tDQSRE) from a time at which the read enable signal nRE starts to toggle. The memory interface circuitry 221 may transmit the data signals DQ including the data “DATA” based on toggle timings of the data strobe signal DQS. Accordingly, the data “DATA” may be transmitted to the storage controller 210 in a state of being aligned with the toggle timings of the data strobe signal DQS.

In a data input operation of the non-volatile memory device 220, when the data signal DQ including data is received from the storage controller 210, the memory interface circuitry 221 may receive the data strobe signal DQS, which toggles, from the storage controller 210 together with the data. The memory interface circuitry 221 may obtain the data from the data signals DQ based on toggle timings of the data strobe signal DQS. For example, the memory interface circuitry 221 may obtain the data by sampling the data signals DQ at the rising edge and the falling edge of the data strobe signal DQS.

The memory interface circuitry 221 may transmit a ready/busy output signal R/nB to the storage controller 210 through the eighth pin P18. The memory interface circuitry 221 may transmit status information of the non-volatile memory device 220 to the storage controller 210 through the ready/busy output signal R/nB When the non-volatile memory device 220 is in a busy state (i.e., when internal operations of the memory device 120 are being performed), the memory interface circuitry 221 may transmit the ready/busy output signal R/nB indicating the busy state to the storage controller 210. When the non-volatile memory device 220 is in a ready state (i.e., when the internal operations of the memory device 220 are not performed or are completed), the memory interface circuitry 221 may transmit the ready/busy output signal R/nB indicating the ready state to the storage controller 210. For example, while the non-volatile memory device 220 reads data from the memory cell array 223 in response to a page read command, the memory interface circuitry 221 may transmit the ready/busy output signal R/nB indicating the busy state (e.g., having the low level) to the storage controller 210. For example, while the non-volatile memory device 220 programs data in the memory cell array 223 in response to the program command, the memory interface circuitry 221 may transmit the ready/busy output signal R/nB indicating the busy state to the storage controller 210. For example, while the non-volatile memory device 220 performs the erase operation on the memory cell array 223 in response to the erase command, the memory interface circuitry 221 may transmit the ready/busy output signal R/nB indicating the busy state to the storage controller 210.

The control logic circuitry 224 may overall control various kinds of operations of the memory device 220. The control logic circuitry 224 may receive the command/address CMD/ADDR obtained from the memory interface circuitry 221. The control logic circuitry 224 may generate control signals for controlling other components of the non-volatile memory device 220 in response to the received command/address CMD/ADDR. For example, the control logic circuitry 224 may generate various kinds of control signals for programming data in the memory cell array 223, reading the data “DATA” from the memory cell array 223, or erasing at least a portion of data stored in the memory cell array 223.

The memory cell array 223 may store the data obtained from the memory interface circuitry 221 under control of the control logic circuitry 224. The memory cell array 223 may output the stored data “DATA” to the memory interface circuitry 221 under control of the control logic circuitry 224. The memory cell array 223 may perform the erase operation on a memory block under control of the control logic circuitry 224.

The storage controller 210 may include first to eighth pins P21 to P28 and controller interface circuitry 213. The first to eighth pins P21 to P28 may respectively correspond to the first to eighth pins P11 to P18 of the non-volatile memory device 220.

The controller interface circuitry 213 may transmit the chip enable signal nCE to the non-volatile memory device 220 through the first pin P21. The controller interface circuitry 213 may transmit and receive signals to and from the non-volatile memory device 220, which is selected by the chip enable signal nCE, through the second to eighth pins P22 to P28.

The controller interface circuitry 213 may transmit the command latch enable signal CLE, the address latch enables signal ALE, and the write enable signal nWE to the non-volatile memory device 220 through the second to fourth pins P22 to P24. The controller interface circuitry 213 may transmit or receive the data signal DQ to and from the non-volatile memory device 220 through the seventh pin P27.

The controller interface circuitry 213 may transmit the data signal DQ including the command CMD or the address ADDR to the non-volatile memory device 220 together with the write enable signal nWE, which toggles. The controller interface circuitry 213 may transmit the data signal DQ including the command CMD to the non-volatile memory device 220 by transmitting the command latch enable signal CLE having an enable state and may transmit the data signal DQ including the address ADDR to the non-volatile memory device 220 by transmitting the address latch enable signal ALE having an enable state.

The controller interface circuitry 213 may transmit the read enable signal nRE to the non-volatile memory device 220 through the fifth pin P25. The controller interface circuitry 213 may receive the data strobe signal DQS from the non-volatile memory device 220 through the sixth pin P26 or may transmit the data strobe signal DQS to the non-volatile memory device 220 through the sixth pin P26.

In the data output operation of the non-volatile memory device 220, the controller interface circuitry 213 may generate the read enable signal nRE which toggles and may transmit the read enable signal nRE to the non-volatile memory device 220. For example, before outputting the data, the controller interface circuitry 213 may generate the read enable signal nRE which is changed from a static state (e.g., a high level or a low level) to a toggling state. Accordingly, the non-volatile memory device 220 may generate the data strobe signal DQS, which toggles, based on the read enable signal nRE. The controller interface circuitry 213 may receive the data signal DQ including the data together with the data strobe signal DQS, which toggles, from the non-volatile memory device 220. The controller interface circuitry 213 may obtain the data from the data signals DQ based on toggle timings of the data strobe signal DQS.

In a data input operation of the non-volatile memory device 220, the controller interface circuitry 213 may generate the data strobe signal DQS which toggles. For example, before transmitting the data, the controller interface circuitry 213 may generate the data strobe signal DQS which is changed from a static state (e.g., a high level or a low level) to a toggling state. The controller interface circuitry 213 may transmit the data signal DQ including data to the non-volatile memory device 220 based on toggle timings of the data strobe signal DQS.

The controller interface circuitry 213 may receive the ready/busy output signal R/nB from the non-volatile memory device 220 through the eighth pin P28. The controller interface circuitry 213 may determine status information of the non-volatile memory device 220 based on the ready/busy output signal R/nB.

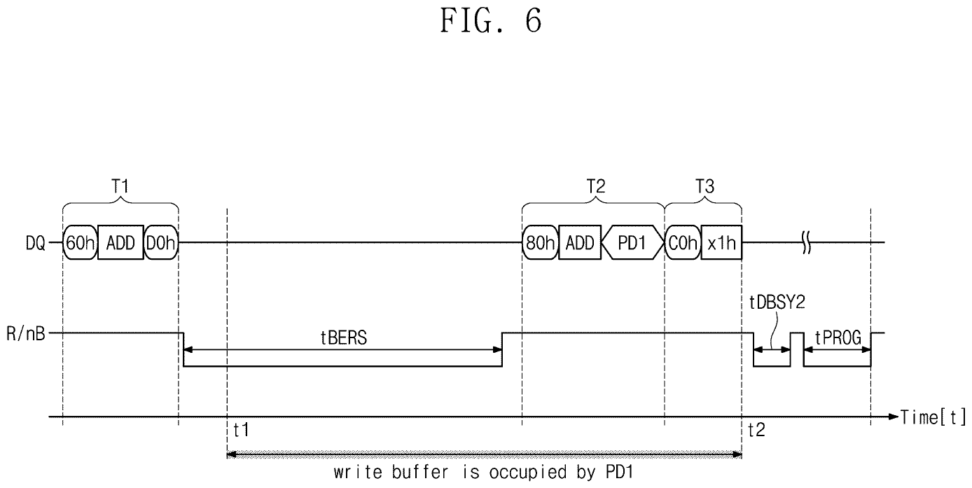

FIG. 6 is a timing diagram describing an erase operation and a program operation of a conventional storage device. In the conventional storage device, the program operation may be performed on a first memory block of a memory cell array and the erase operation preceding the program operation may be performed on the first memory block. For example, the erase operation may be performed on a memory block and after completion of the erase operation, a program command for the program operation may be issued for programming the erased memory block.

Although not illustrated, a non-volatile memory device includes a plurality of non-volatile memories. Each non-volatile memory includes a plurality of memory blocks. The plurality of non-volatile memories are connected to a controller interface circuit through a plurality of channels. For example, a first non-volatile memory among the plurality of non-volatile memories may include a first memory block.

In a first time period T1, a storage controller sequentially transmits a first command 60h, the address ADD, and a second command D0h to the first non-volatile memory. For example, the first command 60h and the second command D0h may constitute an erase command. The address ADD may be an address indicating a physical location of the first memory block to be erased.

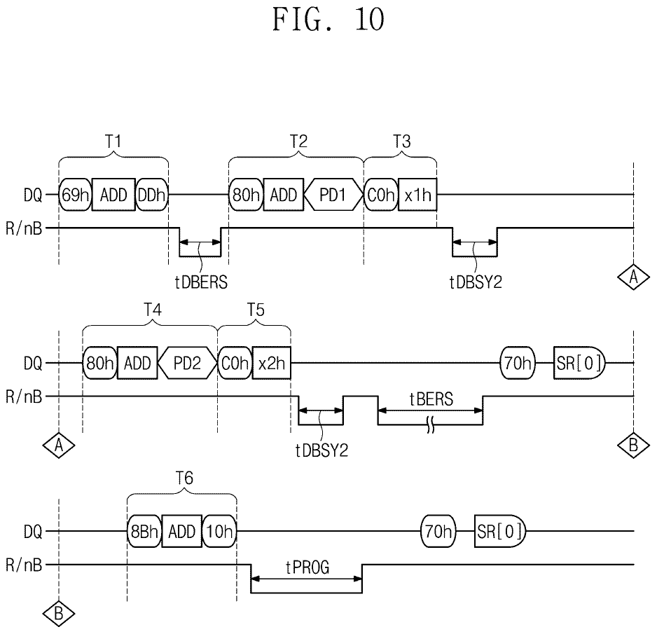

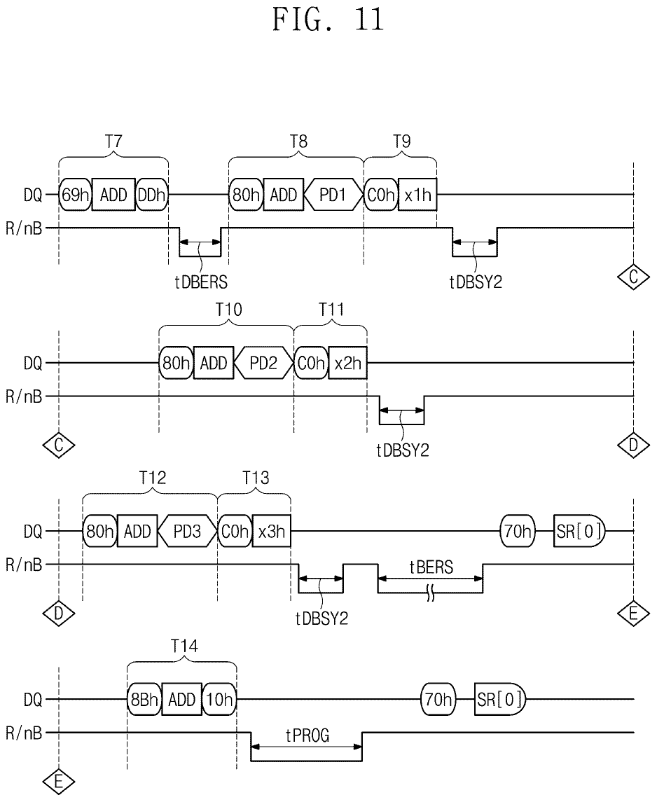

During an erase time tBERS between a first time period T1 and a second time period T2, the non-volatile memory device may perform the erase operation on the first memory block. At a first time point t1 belonging to an erase time period in which the erase operation is performed, the program data may be stored in a write buffer of the storage controller. Although not illustrated for convenience of description, between the first time period T1 and the second time period T2, at least one command may be provided from the storage controller to the non-volatile memory device as the data signal DQ. Alternatively, between the first time period T1 and the second time period T2, at least one data value may be transmitted between the storage controller and the non-volatile memory device as the data signal DQ. This will be described in detail with reference to FIGS. 10 and 11.

In the second time period T2 following the erase time period (i.e., following a time point at which the erase time tBERS elapses and the ready/busy output signal R/nB transitions from the busy state (e.g., a low voltage level of the ready/busy output signal R/nB) to the ready state (e.g., a high voltage level of the ready/busy output signal R/nB)), the storage controller sequentially transmits a third command 80h, the address ADD, and first page data PD1 to the first non-volatile memory. The first page data PD1 to be programmed may correspond to the data stored in the write buffer of the storage controller. For example, the third command 80h may be a program start command, and the address ADD may be an address indicating a physical address of the non-volatile memory device at which the first page data PD1 will be stored.

In a third time period T3, the storage controller sequentially transmits a fourth command C0h and a first latch address x1h to the first non-volatile memory. For example, the fourth command C0h may be a first latch dump command, and the first latch address x1h may be an address indicating a physical address of a first data latch circuit of a page buffer, to which the first page data PD1 will be dumped.

After the third time period T3, during a dump busy time tDBSY2, the first page data PD1 may be dumped to the first data latch circuit.

After the dump busy time tDBSY2 elapses, the first page data PD1 stored in the first data latch circuit may be programmed in the memory cell array during a program time tPROG.

In this case, the write buffer of the storage controller may be occupied by the first page data PD1 from the first time point t1 to a second time point t2 at which the third time period T3 ends.

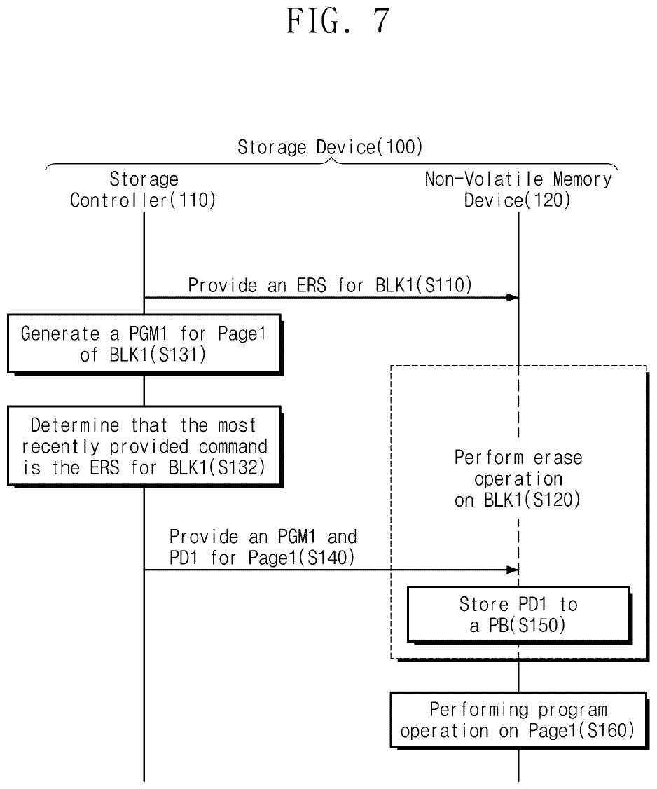

FIG. 7 is a diagram describing an operation method of the storage device 100 according to some embodiments of the present disclosure. Referring to FIG. 7, the storage device 100 may include the storage controller 110 and the non-volatile memory device 120. The storage controller 110 and the non-volatile memory device 120 respectively correspond to the storage controller 110 and the non-volatile memory device 120 of FIG. 1.

In operation S110, the storage controller 110 may transmit an erase command ERS for a first memory block to the non-volatile memory device 120.

In operation S120, the non-volatile memory device 120 may perform the erase operation on the first memory block during the erase time period in response to the erase command ERS.

In operation S131, the storage controller 110 may generate a first program command PGM1 for a first page of the first memory block. However, the scope of the present disclosure is not limited thereto. For example, the first program command PGM1 may be generated before operation S110.

In operation S132, the storage controller 110 determines that an erase command most recently provided to the non-volatile memory device 120 (i.e., an immediately preceding command issued to the non-volatile memory device 120 relative to the issuance of the first program command) is the erase command for the first memory block.

In operation S140, the storage controller 110 may provide the first program command PGM1 to the non-volatile memory device 120 in response to determining that the command most recently provided to the non-volatile memory device 120 is the erase command for the first memory block. In this case, the storage controller 110 may provide the first program command PGM1 to the non-volatile memory device 120 within the erase time period. In an embodiment, the first page data PD1 are provided to the non-volatile memory device 120 together with the first program command PGM1.

In some embodiments, the non-volatile memory device 120 may be in the busy state during the erase time period.

In some embodiments, the erase time period may correspond to an erase time defined by the Toggle DDR 5.1 standard. The Toggle DDR5.1 standard, incorporated herein by reference in its entirety, defines parameters such as an erase time, a program time, and a data transfer timing. As defined in the Toggle DDR5.1 standard, the erase time refers to the duration required to complete a block erase operation, typically on the order of milliseconds (e.g., 3 ms to 5 ms).

In operation S150, the non-volatile memory device 120 may store the first page data PD1 in a page buffer PB.

In an embodiment, operation S150 may include storing, by the non-volatile memory device 120, the first page data PD1 in the cache latch circuit of the page buffer PB, providing, by the storage controller 110, a first latch dump command to the non-volatile memory device 120, and dumping, by the non-volatile memory device 120, the first page data PD1 stored in the cache latch circuit to a first data latch circuit in response to the first latch dump command.

In operation S160, after the erase operation on the first memory block is completed, the non-volatile memory device 120 may program the first page data PD1 stored in the first data latch circuit at a first page of the memory cell array 123.

In other words, during a time when the erase operation is performed on the first memory block and no data input/output is made, the non-volatile memory device 120 may receive the first program command PGM1 and the first page data PD1 from the storage controller 110 and may store the first page data PD1 in the page buffer PB. The storage controller 110 may provide the first program command PGM1 and the first page data PD1 with the non-volatile memory device 120 before the erase operation is completed, and the non-volatile memory device 120 may store the first page data PD1 in the page buffer PB.

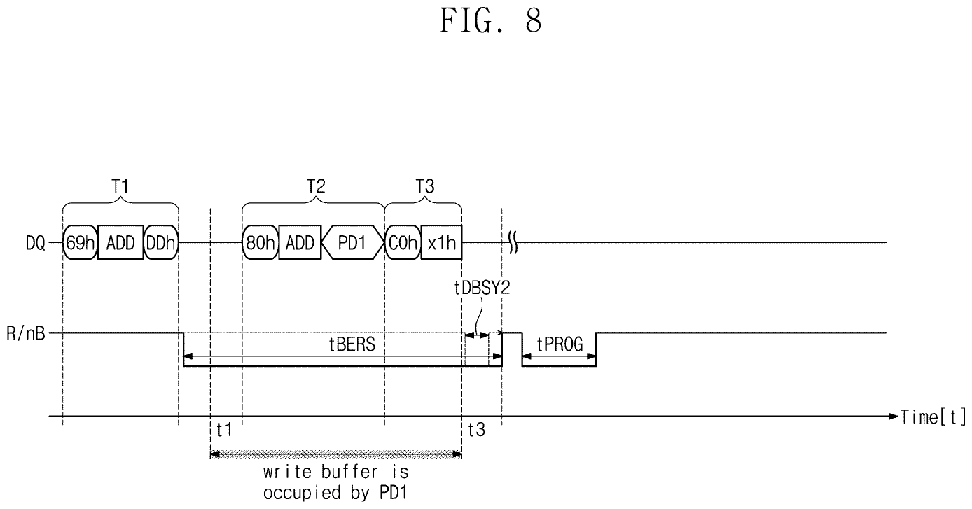

FIG. 8 is a timing diagram describing an erase operation and a program operation of a storage device according to some embodiments of the present disclosure. An example in which the storage device 100 of FIG. 1 performs the program operation on a first memory block of a memory cell array and the erase operation on the first memory block preceding the program operation will be described with reference to FIG. 8.

In the first time period T1, a storage controller sequentially transmits a fifth command 69h, the address ADD, and a sixth command DDh to a first non-volatile memory. For example, the fifth command 69h and the sixth command DDh may constitute an erase command. The address ADD may be an address indicating a physical location of a first memory block to be erased. The erase command according to the present disclosure may be different from the erase command which the conventional storage device of FIG. 6 uses.

After the first time period T1, during the erase time tBERS, the non-volatile memory device 120 may perform the erase operation on the first memory block. At a first time point t1 belonging to the erase time period in which the erase operation is performed, program data may be stored in the write buffer of the storage controller.

During the second time period T2 belonging to the erase time period (i.e., a time period in which the ready/busy output signal R/nB is in the busy state), the storage controller sequentially transmits the third command 80h, the address ADD, and the first page data PD1 to the first non-volatile memory device 120. For example, the third command 80h may be the program start command, and the address ADD may be an address indicating a physical address at which the first page data PD1 will be stored. That is, the storage controller may provide the program command (or the program start command) and program data (e.g., the first page data PD1) to the non-volatile memory device 120 during the time period where the non-volatile memory device 120 is in the busy state. In the third time period T3 belonging to the erase time period (i.e., the time period in which the ready/busy output signal R/nB is in the busy state), the storage controller sequentially transmits the fourth command C0h and the first latch address x1h to the first non-volatile memory. For example, the fourth command C0h may be the first latch dump command, and the first latch address x1h may be an address indicating a physical address of a first data latch circuit of a page buffer, to which the first page data PD1 will be dumped.

After the third time period T3, during the dump busy time tDBSY2, the first page data PD1 may be dumped to the first data latch circuit. However, because the dump busy time tDBSY2 is included in the erase time period, the ready/busy output signal R/nB may continuously be in the busy state without transition.

After the erase time period elapses and the ready/busy output signal R/nB again transitions from the busy state to the ready state, the first page data PD1 stored in the first data latch circuit may be programmed in the memory cell array during the program time tPROG.

In this case, the write buffer of the storage controller may be occupied by the first page data PD1 from the first time point t1 to a third time point t3 at which the third time period T3 ends.

When the non-volatile memory device which performs an erase operation not accompanying the data input/output is in the busy state, the storage device according to the present disclosure may provide page data (e.g., the first page data PD1) to be programmed to the non-volatile memory device. For example, in the erase time period (i.e., at the third time point t3) in which the erase operation is being performed, the storage controller of the storage device may transmit the data signal DQ including the program command and the first page data PD1 to the first non-volatile memory. Accordingly, compared to the conventional storage device (e.g., refer to FIG. 6), a time during which the first page data PD1 occupies the write buffer becomes shorter, and the storage device according to the present disclosure efficiently uses the write buffer.

FIG. 9 is a timing diagram describing a threshold time according to some embodiments of the present disclosure. An operation of comparing the threshold time with a difference between a time point at which the data signal DQ including the fifth command 69h is transmitted and a time point at which there is determined whether to transmit the data signal DQ including the third command 80h will be described with reference to FIG. 9.

Unless separately described, components of FIG. 9 may respectively correspond to components having the same reference signs described with reference to FIG. 8. For convenience, the description which is the same as the description given above will be omitted to avoid redundancy.

At a fourth time period t4, a storage controller may determine whether a command most recently provided to a non-volatile memory device is the erase command. The fourth time period t4 may be between the end of the first time period T1 and the start of the second time period T2.

In some embodiments, when the storage controller determines whether the command most recently provided to the non-volatile memory device is the erase command, the storage controller may together determine whether a first time difference tf1 is smaller than or equal to the threshold time. The first time difference tf1 may indicate a difference between a time point at which the data signal DQ including the fifth command 69h is transmitted to the first non-volatile memory and the fourth time point t4.

In this case, the storage controller may determine that the command most recently provided to the non-volatile memory device is the erase command, and based on determining that the first time difference tf1 is smaller than or equal to the threshold time, the storage controller may sequentially transmit the third command 80h, the address ADD, the first page data PD1, the fourth command C0h, and the first latch address x1h to the first non-volatile memory.

When the first time difference tf1 is greater than the threshold time, as illustrated in FIG. 9, while the third command 80h, the address ADD, the first page data PD1, the fourth command C0h, and the first latch address x1h are sequentially transmitted, the erase time period may be terminated at the fifth time point t5 before the dump busy time elapses.

In some embodiments, the threshold time may be determined in advance. In detail, the threshold time may be a maximum time such that the erase time period is not terminated before the dump busy time elapses in consideration of a dump busy time and a time which the third command 80h, the address ADD, the first page data PD1, the fourth command C0h, and the first latch address x1h are transmitted to the first non-volatile memory.

For example, as illustrated in FIG. 9, the erase time period may be terminated while the data signal DQ including the fourth command C0h is transmitted to the first non-volatile memory.

In some embodiments, instead of determining whether the command most recently provided to the non-volatile memory device is the erase command, the storage controller may only determine whether the first time difference tf1 is smaller than or equal to the threshold time.

FIG. 10 is a timing diagram describing a program operation of a storage device in a multi-level cell (MLC) manner according to some embodiments of the present disclosure. In this case, each memory cell of a memory cell array may store two bits. An operation in which a storage controller sequentially provides a non-volatile memory device with the erase command for a first memory block, a first program command corresponding to least significant bit (LSB) page data of a first page of the first memory block, and a second program command corresponding to most significant bit (MSB) page data of the first page will be described in detail with reference to FIG. 10.

The description associated with the first time period T1, the second time period T2, and the third time period T3 is the same as the description given with reference to FIG. 8, and thus, additional description will be omitted to avoid redundancy. After the third time period T3, during the dump busy time tDBSY2, the first page data PD1 may be dumped to the first data latch circuit of the page buffer. The first page data PD1 may be the LSB page data.

Afterwards, in a fourth time period T4, the storage controller may sequentially transmit the third command 80h, the address ADD, and second page data PD2 to the first non-volatile memory. The third command 80h may be the program start command, the address ADD may be an address indicating a physical location of the first page, and the second page data PD2 may be the MSB page data.

In some embodiments, based on determining that commands most recently provided to the non-volatile memory device are the fifth command 69h and the third command 80h, in the erase time period, the storage controller may provide the non-volatile memory device with the second page data PD2 and the second program command (e.g., the third command 80h in the fourth time period T4) corresponding to the second page data PD2.

In some embodiments, based on determining that a second threshold time does not elapse from a time point at which the erase command for the first memory block is provided to the non-volatile memory device, in the erase time period, the storage controller may provide the non-volatile memory device with the second page data PD2 and the second program command (e.g., the third command 80h in the fourth time period T4) corresponding to the second page data PD2. This will be described in detail with reference to FIG. 12.

In a fifth time period T5, the storage controller may sequentially transmit the fourth command C0h and a second latch address x2h to the first non-volatile memory. The fourth command C0h may be a second latch dump command, and the second latch address x2h may be an address indicating a physical location of a second data latch circuit.

After the fifth time period T5, during the dump busy time tDBSY2, the second page data PD2 may be dumped to the second data latch circuit.

For better understanding, an example in which the erase time tBERS progresses after the fifth time period T5 is illustrated in FIG. 10, but the erase time tBERS actually progresses from a dummy erase time tDBERS to the end of the erase time tBERS illustrated. That is, the actual erase time period may be from the dummy erase time tDBERS to the end of the erase time tBERS illustrated. Also, actually, the ready/busy output signal R/nB indicating the busy state is provided to the storage controller during the erase time period. In other words, an example in which the ready/busy output signal R/nB transitions by the dump busy time tDBSY2 before the erase time tBERS progresses, but it should be understood that the ready/busy output signal R/nB actually maintains the busy state during the erase time period.

After the erase time period, the storage controller may provide a seventh command 70h to the non-volatile memory device. The seventh command 70h may be a status read command. For example, based on the seventh command 70h, the non-volatile memory device may search for a status value SR[0] of the lastly executed operation (e.g., the erase operation). In response to the seventh command 70h, the non-volatile memory device may return the status value SR[0] corresponding to one (e.g., the ready state) of the busy state and the ready state to the storage controller.

In a sixth time period T6, the storage controller may sequentially transmit an eighth command 8Bh, the address ADD, and a ninth command 10h to the first non-volatile memory. The eighth command 8Bh and the ninth command 10h may constitute a confirm command. The address ADD may be an address indicating the physical location of the first page.

Afterwards, during the program time tPROG, the first page data PD1 stored in the first data latch circuit and the second page data PD2 stored in the second data latch circuit may be programmed at the first page of the memory cell array.

After the program time tPROG ends, the storage controller may provide the seventh command 70h to the non-volatile memory device. The seventh command 70h may be the status read command. For example, based on the seventh command 70h, the non-volatile memory device may search for the status value SR[0] of the lastly executed operation (e.g., the program operation). In response to the seventh command 70h, the non-volatile memory device may return the status value SR[0] corresponding to one (e.g., the ready state) of the busy state and the ready state to the storage controller.

FIG. 11 is a timing diagram describing a program operation of a storage device in a triple level cell (TLC) manner according to some embodiments of the present disclosure. In this case, each memory cell of a memory cell array may store three bits. An operation in which a storage controller sequentially provides a non-volatile memory device with the erase command for a first memory block, a first program command corresponding to LSB page data of a first page, a second program command corresponding to center significant bit (CSB) page data of the first page, and a third program command corresponding to MSB page data of the first page will be described in detail with reference to FIG. 11.

A seventh time period T7, an eighth time period T8, a ninth time period T9, a tenth time period T10, and an eleventh time period T11 respectively correspond to the first time period T1, the second time period T2, the third time period T3, the fourth time period T4, and the fifth time period T5 of FIG. 10, and thus, the same description as given with reference to 10 will be omitted to avoid redundancy. After the ninth time period T9, during the dump busy time tDBSY2, the first page data PD1 are dumped to the first data latch circuit as the LSB page data. After the eleventh time period T11, during the dump busy time tDBSY2, the second page data PD2 are dumped to the second data latch circuit as the CSB page data.

Afterwards, in a twelfth time period T12, the storage controller may sequentially transmit the third command 80h, the address ADD, and third page data PD3 to the first non-volatile memory. The sixth command DDh may be a third program start command, the address ADD may be an address indicating a physical location of the first page, and the third page data PD3 may be the MSB page data.

In a thirteenth time period T13, the storage controller sequentially may sequentially transmit the seventh command 70h and a second latch address x3h to the first non-volatile memory. The seventh command 70h may be a third latch dump command, and the third latch address x3h may be an address indicating a physical location of a third data latch circuit.

After the thirteenth time period T13, during the dump busy time tDBSY2, the third page data PD3 may be dumped to the third data latch circuit as the MSB page data.

For better understanding, like FIG. 10, an example in which the erase time tBERS progresses after the thirteenth time period T13 is illustrated in FIG. 11, but the erase time tBERS actually progresses from the dummy erase time tDBERS to the end of the erase time tBERS illustrated. That is, the actual erase time period may be from the dummy erase time tDBERS to the end of the erase time tBERS illustrated. Also, actually, the ready/busy output signal R/nB indicating the busy state is provided to the storage controller during the erase time period. In other words, an example in which the ready/busy output signal R/nB transitions by the dump busy time tDBSY2 before the erase time tBERS progresses, but it should be understood that the ready/busy output signal R/nB actually maintains the busy state during the erase time period.

After the erase time period, the storage controller may provide a seventh command 70h to the non-volatile memory device. The seventh command 70h may be the status read command. For example, based on the seventh command 70h, the non-volatile memory device may search for a status value SR[0] of the lastly executed operation (e.g., the erase operation). In response to the seventh command 70h, the non-volatile memory device may return the status value SR[0] corresponding to one (e.g., the ready state) of the busy state and the ready state to the storage controller.

In some embodiments, the non-volatile memory device may provide the storage controller with a response indicating the failure of the erase operation. In this case, for example, the storage controller may provide the non-volatile memory device with a command for changing a row address corresponding to the program command. The non-volatile memory device may store the first to third page data PD1 to PD3 in a second memory block, not the first memory block. As another example, the storage controller may provide the non-volatile memory device with a command for reading the first to third page data PD1 to PD3 stored in the page buffer. The storage controller may again perform the program operation based on the first to third page data PD1 to PD3 obtained from the non-volatile memory device after the following erase operation is successfully performed.

In a fourteenth time period T14, the storage controller may sequentially transmit the eighth command 8Bh, the address ADD, and the ninth command 10h to the first non-volatile memory. The eighth command 8Bh and the ninth command 10h may constitute the confirm command. The address ADD may be an address indicating the physical location of the first page.

Afterwards, during the program time tPROG, the first page data PD1 stored in the first data latch circuit, the second page data PD2 stored in the second data latch circuit, and the third page data PD3 stored in the third data latch circuit may be programmed at the first page of the memory cell array.

After the program time tPROG ends, the storage controller may provide the seventh command 70h to the non-volatile memory device. The seventh command 70h may be the status read command. For example, based on the seventh command 70h, the non-volatile memory device may search for the status value SR[0] of the lastly executed operation (e.g., the program operation). In response to the seventh command 70h, the non-volatile memory device may return the status value SR[0] corresponding to one (e.g., the ready state) of the busy state and the ready state to the storage controller.

FIG. 12 is a timing diagram describing a threshold time according to some embodiments of the present disclosure. An operation of comparing a first threshold time and a difference between a time point at which the data signal DQ including the erase command is transmitted and a time point at which whether to transmit the first program command PGM1 is determined, a second threshold time and a difference between the time point at which the data signal DQ including the erase command is transmitted and a time point at which whether to transmit the second program command PGM2 is determined, and a third threshold time and a difference between the time point at which the data signal DQ including the erase command is transmitted and a time point at which whether to transmit the third program command PGM3 is determined will be described with reference to FIG. 12.

In some embodiments, the first to third program commands PGM1 to PGM3 may be sequentially generated in response to the program requests for first to third page data. For example, a non-volatile memory device may perform the program operation in the TLC manner. The first to third page data may respectively correspond to the LSB, CSB, and MSB page data. However, the scope of the present disclosure is not limited thereto. For example, the order of generating the first to third program commands PGM1 to PGM3 and the order of transmitting the first to third program commands PGM1 to PGM3 may be variously changed.

At a sixth time point t6, a storage controller may determine whether a first threshold time does not elapse from a time point at which the erase command ERS is transmitted. Whether the first time difference tf1 is smaller than or equal to the first threshold time may be determined. The first time difference tf1 may indicate a difference between a time point at which the storage controller transmits the erase command ERS and the sixth time point t6.

When the first time difference tf1 is greater than the first threshold time, the erase time period may be terminated before the first to third page data are stored in the page buffer based on the first to third program commands PGM1 to PGM3.

In some embodiments, the first threshold time may be determined in advance. In detail, in consideration of a time from a time point at which the first program command PGM1 is transmitted to the time point at which all the first to third page data are stored in the page buffer, the first threshold time may be a maximum time such that the erase time period is not terminated before the dump busy time elapses.

At a seventh time point t7, the storage controller may determine whether a second threshold time does not elapse from a time point at which the erase command ERS is transmitted. Whether the second time difference tf2 is smaller than or equal to a second threshold time may be determined. The second time difference tf2 may indicate a difference between the time point at which the storage controller transmits the erase command ERS and the seventh time point t7.

When the second time difference tf2 is greater than the second threshold time, the erase time period may be terminated before the first to third page data are stored in the page buffer based on the first to third program commands PGM1 to PGM3.

In some embodiments, the second threshold time may be determined in advance. In detail, in consideration of a time from a time point at which the second program command PGM2 is transmitted to the time point at which all the first to third page data are stored in the page buffer, the second threshold time may be a maximum time such that the erase time period is not terminated before the dump busy time elapses.

At an eighth time point t8, the storage controller may determine whether a third threshold time does not elapse from a time point at which the erase command ERS is transmitted. Whether a third time difference tf3 is smaller than or equal to a third threshold time may be determined. The third time difference tf3 may indicate a difference between the time point at which the storage controller transmits the erase command ERS and the eighth time point t8.

When the third time difference tf3 is greater than the third threshold time, the erase time period may be terminated before the first to third page data are stored in the page buffer based on the first to third program commands PGM1 to PGM3.

In some embodiments, the third threshold time may be determined in advance. In detail, in consideration of a time from a time point at which the third program command PGM3 is transmitted to the time point at which all the first to third page data are stored in the page buffer, the third threshold time may be a maximum time such that the erase time period is not terminated before the dump busy time elapses.

FIG. 13 is a flowchart describing an operation method of a storage device according to some embodiments of the present disclosure. The operation method of the storage device 100 of FIG. 1 will be described with reference to FIG. 13. A storage device may include a storage controller and a non-volatile memory device.

In operation S210, the storage controller of the storage device may generate the first program command PGM1 for the first page of the first memory block.

In operation S220, the storage controller of the storage device may determine that a command most recently provided to the non-volatile memory device is the erase command ERS.

In operation S230, the storage controller of the storage device may determine that a threshold time does not elapse from a time point at which the erase command ERS is provided to the non-volatile memory device.

In operation S240, the storage controller of the storage device may provide the first program command PGM1 to the non-volatile memory device in the erase time period in response to the determination of the threshold time not elapsing from the time point at which the erase command ERS is provided to the non-volatile memory device.

In some embodiments, during the erase time period, the ready/busy output signal may indicate the busy state.

In some embodiments, the erase time period may correspond to the erase time defined by the Toggle DDR 5.1 standard.

In operation S250, the non-volatile memory device of the storage device may store the first page data PD1 corresponding to the first program command PGM1 in the page buffer in the erase time period.

In some embodiments, operation S250 may include storing, by the non-volatile memory device, first page data in the cache latch circuit of the page buffer, providing, by the storage controller, a first latch dump command for the first page data to the non-volatile memory device, and dumping, by the non-volatile memory device, the first page data stored in the cache latch circuit to a first data latch circuit of the page buffer based to the first latch dump command.

In some embodiments, operation S250 may further include providing, by the storage controller, a second program command for the first page of the first memory block to the non-volatile memory device at a second time point after a first time point in the erase time period, and storing, by the non-volatile memory device, second page data corresponding to the second program command in the page buffer. In this case, each memory cell of a memory cell array may store at least two or more bits. For example, the first page data may be the LSB page data, and the second page data may be the MSB page data.

In addition, operation S250 may further include providing, by the storage controller, a third program command for the first page of the first memory block to the non-volatile memory device at a third time point after the second time point in the erase time period, and storing, by the non-volatile memory device, third page data corresponding to the third program command in the page buffer. In this case, each memory cell of a memory cell array may store at least two or more bits. For example, the first page data may be the LSB page data, the second page data may be the CSB page data, and the third page data may be the MSB page data.

A method of storing (or dumping) the second page data and the third page data to the page buffer is similar to processing for the first page data.

In some embodiments, the non-volatile memory device may program the first page data stored in the page buffer after the completion of the erase operation in the memory cell array of the non-volatile memory device.

According to an embodiment of the present disclosure, a storage system reducing a write buffer occupancy time in a program operation, an operation method of a storage device, and an operation method of a storage controller are provided.

The storage device according to the present disclosure may reduce the occupancy time of the write buffer by providing a non-volatile memory device with to-be-programmed page data transmitted to the non-volatile memory device during an erase operation without a data input/output and storing the page data in a page buffer.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An operation method of a storage device which includes a storage controller and a non-volatile memory device, the method comprising:
providing, by the storage controller, an erase command to the non-volatile memory device; and
providing, by the storage controller, the non-volatile memory device with a first program command and first page data during an erase time period in which the non-volatile memory device is in a busy state in response to the erase command.

2. The method of claim 1, further comprising:
transmitting, by the non-volatile memory device, a ready/busy output signal to the storage controller in response to the erase command,
wherein the ready/busy output signal indicates the busy state of the non-volatile memory device during the erase time period.

3. The method of claim 1, further comprising:
storing, by the non-volatile memory device, the first page data in a page buffer of the non-volatile memory device during the erase time period.

4. The method of claim 3,
wherein the storing of the first page data in the page buffer of the non-volatile memory device during the erase time period by the non-volatile memory device includes:
storing, by the non-volatile memory device, the first page data in a cache latch circuit of the page buffer;
providing, by the storage controller, a first latch dump command for the first page data to the non-volatile memory device; and
dumping, by the non-volatile memory device, the first page data stored in the cache latch circuit to a first data latch circuit of the page buffer, based on the first latch dump command.

5. The method of claim 3, further comprising:
programming, by the non-volatile memory device, the first page data stored in the page buffer in a memory cell array of the non-volatile memory device, after the erase time period.

6. The method of claim 3, further comprising:
providing, by the storage controller, a status read command to the non-volatile memory device after the erase time period;
providing, by the non-volatile memory device, a status value indicating a ready state to the storage controller in response to the status read command;
providing, by the storage controller, a confirm command to the non-volatile memory device; and
programming, by the non-volatile memory device, the first page data stored in the page buffer in a memory cell array of the non-volatile memory device, based on the confirm command.

7. The method of claim 1,
wherein the erase time period corresponds to an erase time defined by a Toggle DDR 5.1 standard.

8. The method of claim 1,
wherein the providing of the non-volatile memory device with the first program command and the first page data during the erase time period by the storage controller includes:
determining, by the storage controller, whether an immediately preceding command issued to the non-volatile memory device is the erase command for a first memory block corresponding to the first program command; and
providing, by the storage controller, the first program command and the first page data to the non-volatile memory device, in response to determining that the immediately preceding command is the erase command.

9. The method of claim 8,
wherein the determining, by the storage controller, whether that the immediately preceding command issued to the non-volatile memory device is the erase command includes:
determining, by the storage controller, whether a threshold time does not elapse from a time point at which the erase command is provided to the non-volatile memory device.

10. The method of claim 1,
wherein the erase command indicates an erase operation associated with a first memory block of the non-volatile memory device, and
wherein the first program command indicates a program operation associated with a first page of the first memory block.

11. The method of claim 10, further comprising:
providing, by the storage controller, the non-volatile memory device with a second program command and second page data associated with a second page of the first memory block, during the erase time period.

12. The method of claim 11,
wherein the non-volatile memory device performs a program operation in a multi-level cell (MLC) manner,
wherein the first page data are least significant bit (LSB) page data, and
wherein the second page data are most significant bit (MSB) page data.

13. The method of claim 11, further comprising:
providing, by the storage controller, the non-volatile memory device with a third program command and third page data associated with a third page of the first memory block, during the erase time period.

14. The method of claim 13,
wherein the non-volatile memory device performs a program operation in a triple level cell (TLC) manner,
wherein the first page data are LSB page data,
wherein the second page data are center significant bit (CSB) page data, and
wherein the third page data are MSB page data.

15. An operation method of a storage controller which communicates with a non-volatile memory device, the method comprising:
providing the non-volatile memory device with an erase command for a first memory block of the non-volatile memory device; and
providing the non-volatile memory device with a first program command and first page data during an erase time period in which the non-volatile memory device is in a busy state in response to the erase command.

16. The method of claim 15, further comprising:
providing a first latch dump command for the first page data to the non-volatile memory device during the erase time period.

17. The method of claim 15,
wherein the erase command corresponds to the first memory block of the non-volatile memory device, and
wherein the first program command corresponds to a first page of the first memory block.

18. The method of claim 15, further comprising:
providing a second program command and second page data to the non-volatile memory device, during the erase time period,
wherein the non-volatile memory device performs a program operation in a multi-level cell (MLC) manner,
wherein the first page data are least significant bit (LSB) page data, and
wherein the second page data are most significant bit (MSB) page data.

19. The method of claim 15, further comprising:
providing a second program command and second page data to the non-volatile memory device, during the erase time period; and
providing a third program command and third page data to the non-volatile memory device, during the erase time period,
wherein the non-volatile memory device performs a program operation in a triple level cell (TLC) manner,
wherein the first page data are LSB page data,
wherein the second page data are center significant bit (CSB) page data, and
wherein the third page data are MSB page data.

20. A storage system comprising:
a host; and
a storage device including a storage controller and a non-volatile memory device, and configured to communicate with the host,
wherein the storage controller is configured to:
receive a program request provided from the host;
provide the non-volatile memory device with an erase command for a first memory block of the non-volatile memory device, based on the program request; and
provide the non-volatile memory device with a first program command and first page data associated with a first page of the first memory block, during an erase time period in which the non-volatile memory device is in a busy state in response to the erase command.
